(19) United States
(12) Patent Application Publication
(10) Pub. No.: US 2009/0269057 A1
(43) Pub. Date: Oct. 29, 2009

(54) WAVELENGTH ROUTE SELECTION SYSTEM AND WAVELENGTH ROUTE SELECTION METHOD

(76) Inventor: HIROAKI TANAKA, Tokyo (JP)

Correspondence Address: NEC CORPORATION OF AMERICA, 6535 N. STATE HWY 161, IRVING, TX, 75039, US

(21) Appl. No.: 12/428,956

(22) Filed: Apr. 23, 2009

(30) Foreign Application Priority Data
Apr. 25, 2008 (JP) P2008-116328

(51) Int. Cl. H04B 10/08

(52) U.S. Cl. 398/34

(57) ABSTRACT

A wavelength route selection system includes an inhibition route setting unit determining, for each of the spans, whether or not the span reliability exceeds the upper limit value, and extracting, as second wavelength routes, routes based on spans, the span reliability of which is determined to exceed the upper limit value, from among wavelength routes from the node device as the start point to the node device as the end point. The system further includes a route reliability calculation unit adding, for each of the second wavelength routes extracted by the inhibition route setting unit, the span reliabilities of all the spans in the corresponding second wavelength route calculated so as to calculate a wavelength route reliability representing the reliability of the second wavelength route. The system further includes a route selection unit selecting a second wavelength route having a minimum wavelength route reliability calculated by the route reliability calculation unit from among the second wavelength routes as the first wavelength route.

This application is based upon and claims priority from Japanese Patent Application No. 2008-116328 filed Apr. 25, 2008, the content of which is incorporated herein by reference.

### BACKGROUND OF THE INVENTION

1. Field of the Invention

The present invention relates to a wavelength route selection system and a wavelength route selection method.

2. Description of Related Art

In recent years, in the field of wavelength division multiplexing networks having a wavelength cross-connect function for switching routes of an optical signal, when a wavelength path of high importance is set, it is demanded to select a route with as few faults as possible. In the field of optical transmission, with respect to route selection, a technique disclosed in Japanese Unexamined Patent Application, First Publication No. 2007-082086 (Patent Document 1) is known. Patent Document 1 discloses that a monitor signal is added, and route selection is carried out using the OSNR (optical signal-to-noise ratio) as an evaluation value. A technique is also known in which route quality evaluation is carried out on the basis of the error rate of a main signal or a packet error rate. For example, this technique is disclosed in Japanese Unexamined Patent Application, First Publication No. H08-191308 (Patent Document 2).

A relay node having a wavelength cross-connect function relays an input optical signal as it is. For this reason, the OSNR based on the monitor signal, which is obtained only with conversion of an optical signal into an electrical signal, or the error rate of the main signal or the packet error rate cannot be used as the evaluation value for route selection.

The invention has been finalized in consideration of the above situation and in order to solve the above problems, and has as its object to provide a wavelength route selection system and a wavelength route selection method which are capable of realizing a few-fault route selection processing in a wavelength division multiplexing network without requiring time and effort, or addition or replacement of various devices with respect to an existing system.

### SUMMARY

In one embodiment, there is provided a wavelength route selection system of the present invention comprising: a data collection unit receiving span status information representing status of each of spans for connection to the different node devices to the spans from a plurality of node devices; a span reliability calculation unit calculating span reliabilities of each of the spans on the basis of the span status information received by the data collection unit; an inhibition route setting unit determining, for each of the spans, whether or not the span reliability calculated by the span reliability calculation unit exceeds an upper limit value of the span reliability representing the reliability of each of the spans, and extracting, as second wavelength routes, routes based on spans, the span reliability of which is determined to exceed the upper limit value, from among wavelength routes from the node device as the start point to the node device as the end point; a route reliability calculation unit adding, for each of the second wavelength routes extracted by the inhibition route setting unit, the span reliabilities of all the spans in the corresponding second wavelength route calculated by the span reliability calculation unit so as to calculate a wavelength route reliability representing the reliability of the second wavelength route; a route selection unit selecting the second wavelength route having a minimum wavelength route reliability calculated by the route reliability calculation unit from among the second wavelength routes as the first wavelength route from one of the node devices as a start point to another of the node devices as an end point; and a setting unit setting the first wavelength route selected by the route selection unit in the plurality of node devices.

In one embodiment, there is provided a wavelength route selection system of the present invention wherein the span status information includes an alarm of a wavelength multiplexed signal, quality supervision information of the wavelength multiplexed signal, an alarm of a supervision control signal, and quality supervision information of the supervision control signal.

In one embodiment, there is provided a wavelength route selection system of the present invention wherein the span reliability calculation unit calculates the span reliability on the basis of current span status information and past span status information from among the span status information.

In one embodiment, there is provided a wavelength route selection method of the present invention comprising: receiving span status information representing status of each of spans for connection to the different node devices to the spans from node devices; calculating span reliabilities of each of the spans on the basis of the received span status information and weighted values for the respective span status information; determining, for each of the spans, whether or not the calculated span reliability exceeds an upper limit value of the span reliability representing the reliability of each of the spans, and extracting, as second wavelength routes, routes based on spans, the span reliability of which is determined to exceed the upper limit value, from among wavelength routes from the node device as the start point to the node device as the end point; adding, for each of the extracted second wavelength routes, the span reliabilities of all the spans in the corresponding second wavelength route so as to calculate a wavelength route reliability representing the reliability of the second wavelength route; selecting the second wavelength route having a minimum wavelength route reliability from among the second wavelength routes as the first wavelength route from one of the node devices as a start point to another of the node devices as an end point; and setting the selected first wavelength route in the plurality of node devices.

In one embodiment, there is provided a function for ease of expansion from an existing system and automatic selection of a route of a wavelength path with high reliability using alarms and quality supervision information of wavelength multiplexed light and an SV signal in the existing system as span reliability information between nodes.

According to the embodiment, in the wavelength division multiplexing network having a plurality of node devices, span status information that is reliability information of a span connecting node devices is acquired from the node devices. For each span, the span reliability is calculated on the basis of the acquired span status information. The wavelength route candidates are extracted in accordance with spans, excluding spans whose span reliability exceeds an upper limit value. Accordingly, candidate routes are limited. For this reason, the scale of the route selection processing can be suppressed.

Therefore, a route selection system for selecting a wavelength path with high reliability can be provided with no significant change of an existing system, for example, addition of devices or the like.

As a result, the span reliability calculation unit can calculate the span reliability from more span status information including current and past span status information, rather than only from current span status information, and thus the accuracy of the span reliability can be improved.

### BRIEF DESCRIPTION OF THE DRAWINGS

The above features and advantage of the present invention will be more apparent from the following description of certain preferred embodiments taken in conjunction with the accompanying drawings, in which:

FIG. 1 shows the overall configuration of a wavelength route selection system A and a wavelength division multiplexing network N according to an embodiment of the invention:

FIG. 2 shows an example of weighted values of reliability for respective status information stored in a condition setting input unit A-1 according to the embodiment of the invention;

FIG. 3 shows the operation flow of a wavelength route selection system A according to the embodiment of the invention;

FIG. 4 shows the configuration of a wavelength division multiplexing network N-2 according to the embodiment of the invention;

FIG. 5 shows status information of a span P1-4 and weighted values for respective status information;

FIG. 6 shows the correspondence between nodes connected to a node through spans other than an inhibition span of the corresponding node and the span reliabilities R of the spans according to the embodiment of the invention;

FIG. 7 shows a conceptual diagram of a route extraction processing of an inhibition route setting unit A-5 according to the embodiment of the invention;

FIG. 8 shows tie correspondence between nodes connected to a node through all spans other than an inhibition span of the corresponding node and the span reliabilities R of the spans according to the embodiment of the invention;

FIG. 9 shows a conceptual view of a route extraction processing with no exception of an inhibition span according to the embodiment of the invention; and

FIG. 10 shows a conceptual view of a route extraction processing with no exception of an inhibition span according to the embodiment of the invention.

### DETAILED DESCRIPTION OF PREFERRED EMBODIMENTS

Hereinafter, a wavelength route selection system A according to an embodiment of the invention will be described with reference to the drawings.

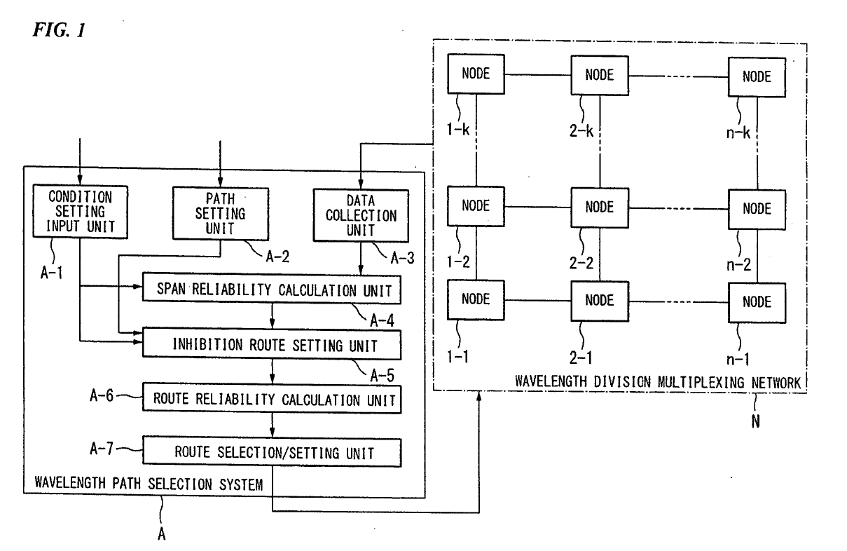

FIG. 1 is a schematic block diagram showing a wavelength route selection system A according to this embodiment and a wavelength division multiplexing network N that is connected to the wavelength route selection system A. The wavelength division multiplexing network N includes a plurality of nodes each having a wavelength cross-connect function, for example, nodes 1-1 to n-k that are arranged in a lattice shape of k vertical by n horizontal. The nodes 1-1 to n-k are also called node devices. Each of the nodes 1-1 to n-k is connected to adjacent nodes. Each of the nodes 1-1 to n-k carries out a wavelength cross-connect processing by switching output destinations of an input optical signal for each wavelength of the optical signal. In the following description, connection between the nodes 1-1 to n-k is also called a span. Switching of the output destinations of the optical signal is also called span switching or span selection.

In the wavelength division multiplexing network N, each of the nodes 1-1 to n-k has a wavelength cross-connect function and a function to output status information of spans between the corresponding node and other nodes connected to the corresponding node. The span status information is reliability information, such as an alarm, quality supervision information, and the like. Specifically, the span status information includes eight kinds of status information of current and past alarms of wavelength multiplexed light regarding the level (intensity) of wavelength multiplexed light, current and past quality supervision status information of wavelength multiplexed light, current and past alarms of a supervision control signal (SV signal (Supervision)) regarding a signal error rate, and current and past quality supervision status information of the SV signal. The past status information, that is, the history of status information is status information that is detected for a predetermined period, for example, for several days.

The wavelength route selection system A includes a condition setting input unit A-1, a path setting unit A-2, a data collection unit A-3, a span reliability calculation unit A4, an inhibition route setting unit A-5, a route reliability calculation unit A-6, and a route selection/setting unit A-7. The wavelength route selection system A executes a wavelength route selection processing in the wavelength division multiplexing network N. The wavelength route selection system A is connected to the nodes 1-1 to n-k of the wavelength division multiplexing network N through control signal lines to communicate with the nodes 1-1 to n-k. In FIG. 1, for ease of understanding of the drawings, the control signal lines connecting the wavelength route selection system A and the nodes 1-1 to n-k are shown as connection lines connecting the wavelength route selection system A and the wavelength division multiplexing network N.

In the wavelength route selection system A, the condition setting input unit A-1 includes an input device, such as a keyboard, a mouse, a touch panel, buttons, or keys, and a storage unit having various memories. The condition setting input unit A-1 detects an operation by an operator on the input device, and stores the detection result in the storage unit as route selection condition information based on the operator's input. The route selection condition information is information representing restrictions when route selection is carried out. The contents of the restrictions in the route selection condition information include information regarding, for example, an upper limit reliability threshold α, a weighted value of a reliability, and the like, which will be described below and used for the route selection processing.

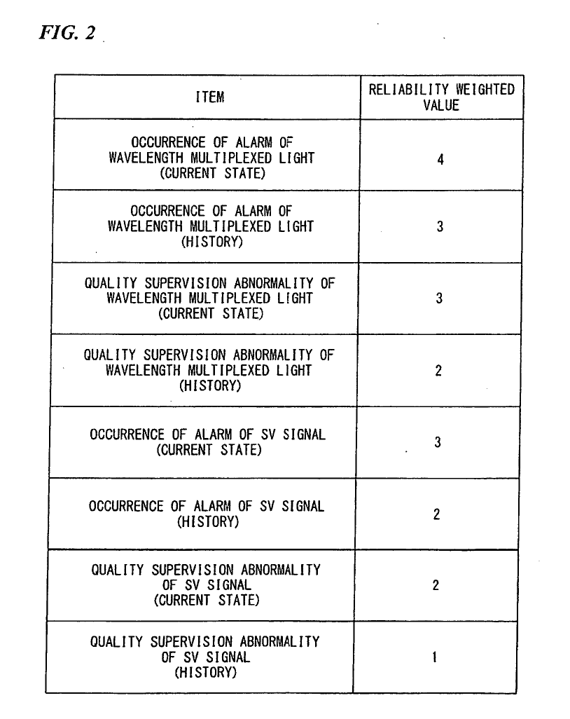

FIG. 2 shows an example of weighted values of reliability for respective status information stored in the condition setting input unit A-1. The weighted value of reliability is appended to status information that is detected at each of the nodes 1-1 to n-k. The status information represents the occurrence of alarms and abnormality of quality supervision information.

Returning to FIG. 1, the path setting unit A-2 includes an input device, such as a keyboard, a mouse, a touch panel, button, or keys, and a storage unit having various memories. The path setting unit A-2 detects an operation by the operator on the input device, and stores the detection result in the storage unit as wavelength path information based on the operator's input.

The wavelength path information is information that includes identification information of a start node and identification information of an end node of a wavelength path subject to wavelength route selection.

The data collection unit A-3 internally includes a storage unit having various memories. The data collection unit A-3 is connected to the nodes 1-1 to n-k through the control signal lines. The data collection unit A-3 acquires status information of spans from the nodes 1-1 to n-k, and stores the acquired status information in the storage unit in association with the identification information of the respective nodes.

With respect to the status information acquired from the nodes 1-1 to n-k by the data collection unit A-3, the data collection unit A-3 may transmit a status information output request to the nodes 1-1 to n-k and acquire status information from a response signal for the output request Alternatively, when status information changes, the nodes 1-1 to n-k may output the changed status information to die data collection unit A-3, and the data collection unit A-3 may acquire status information.

The span reliability calculation unit A-4 reads out the status information stored in the data collection unit A-3 and the weighted values stored in the condition setting input unit A-1. The span reliability calculation unit A-4 calculates the span reliability R of each span on the basis of the status information and the weighted values. In this embodiment, the span reliability calculation unit A-4 calculates the span reliability R of each span by adding the weighted values of reliability. Therefore, the lower the span reliability R is, the higher reliability the corresponding span is. The higher the span reliability R is, the lower reliability the corresponding span is.

The span reliability calculation unit A-4 outputs an inhibition span exclusion/route extraction request including the calculated span reliability R of each span to the inhibition route setting unit A-5.

If the inhibition span exclusion/route extraction request is input, the inhibition route setting unit A-5 reads out the upper limit reliability threshold α stored in the condition setting input unit A-1. The inhibition route setting unit A-5 determines, as an inhibition span, a span whose span reliability R exceeds the upper limit reliability threshold α. The inhibition route setting unit A-5 reads out the identification information of the start node and the end node from the path setting unit A-2. The inhibition route setting unit A-5 extracts routes based on spans excluding the determined inhibition span as a route from the start node to the end node. The inhibition route setting unit A-5 outputs a request to calculate a route reliability R′ including information regarding the extracted routes and the span reliability R of each span to the route reliability calculation unit A-6.

In response to the request to calculate the route reliability R′, for each route, the route reliability calculation unit A-6 calculates the route reliability R′ by adding the span reliability R of each span in the corresponding route. The route reliability calculation unit A-6 outputs a route selection/setting request including the calculated route reliability R′ of each route to the route selection/setting unit A-7.

In response to the route selection/setting request, the route selection/setting unit A-7 determines a route having a minimum route reliability R′ as a wavelength path with high reliability from the start node to the end node. The route selection/setting unit A-7 is connected to the nodes 1-1 to n-k through the control signal lines. The route selection/setting unit A-7 outputs a route setting request to the nodes 1-1 to n-k on the basis of the wavelength path determination result.

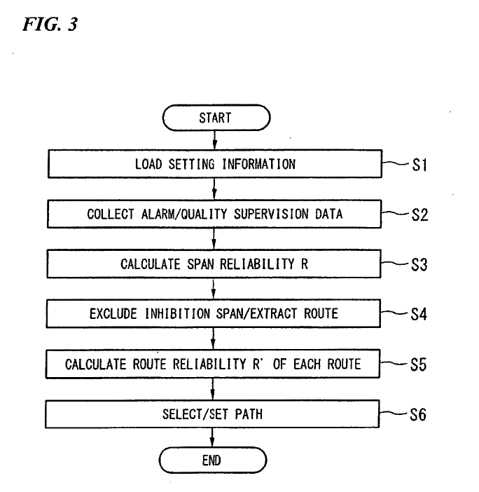

Next, the flow of a processing in the wavelength route selection system A according to this embodiment will be described with reference to the drawing. FIG. 3 is a flowchart showing the flow of a processing in the wavelength route selection system A.

In the wavelength route selection system A, the condition setting input unit A-1 accepts an input of route selection condition information on the basis of the operation by the operator on the input unit. The condition setting input unit A-1 stores the input route selection condition information in the internal storage unit. The route selection condition information represents restrictions when route selection is carried out. The contents of the restrictions include upper limit reliability threshold α at the time of route selection and the weighted values for the respective status information of FIG. 2.

The path setting unit A-2 accepts an input of route path information on the basis of the operation by the operator on the input unit. The path setting unit A-2 stores the input route path information in the internal storage unit (Step S1). The route path information includes the identification information of the start node and the identification information of the end node of the wavelength path subject to route selection, as described above.

The data collection unit A-3 acquires status information of the nodes 1-1 to n-k, and stores the acquired status information in the internal storage unit in association with the identification information of the nodes (Step S2).

The span reliability calculation unit A-4 reads out status information data for the respective nodes from the data collection unit A-3, and also reads out the weighted values stored in the condition setting input unit A-1. The span reliability calculation unit A-4 calculates the reliability R of each span on the basis of the read weighted values (Step S3). The span reliability calculation unit A-4 outputs the inhibition span exclusion/route extraction request including the calculated span reliability R to the inhibition route setting unit A-5.

The reliability R of each span is obtained by addition of the weighted values of reliability of all the items in FIG. 2. The weighted value of each item in FIG. 2 is an example. The operator may perform an input to change the weighted value with respect to the condition setting input unit A-1 so as to change the settings.

The inhibition route setting unit A-5 reads out the upper limit reliability threshold α from the condition setting input unit A-1. The inhibition route setting unit A-5 compares the span reliability R of each span calculated by the span reliability calculation unit A-4 with the read upper limit reliability threshold α, and determines, as inhibition span, a span satisfying the condition R>α. The inhibition route setting unit A-5 reads the identification information of the start node and the end node from the path setting unit A-2. The inhibition route setting unit A-5 extracts routes based on spans excluding the determined inhibition span as a route from the start node to the end node (Step S4). The inhibition route setting unit A-5 outputs the request to calculate the route reliability R′ including information regarding the extracted routes and the span reliability R of each span to the route reliability calculation unit A-6.

The route reliability calculation unit A-6 calculates the route reliability R′ for the respective routes extracted by the inhibition route setting unit A-5 (Step S5). The route reliability R′ is calculated by addition of the span reliabilities R of all the spans in each route subject to reliability calculation. That is, the route reliability R′ is the sum of the span reliabilities R of the spans in the corresponding route. The route reliability calculation unit A-6 outputs the route selection/setting request including the calculated route reliability R′ for each route and the information regarding the routes input from the inhibition route setting unit A-5 to the route selection/setting unit A-7.

The route selection/setting unit A-7 compares the route reliabilities R′ of all the routes with each other. The route selection/setting unit A-7 selects and sets a route having a minimum route reliability R′ as a wavelength path with high reliability from the start node to the end node (Step S6). The route selection/setting unit A-7 transmits a setting information update request including setting information with respect to the wavelength cross-connect function provided in each of the nodes 1-1 to n-k of the wavelength division multiplexing network N. Accordingly, the route selection/setting unit A-7 updates setting information in the nodes 1-1 to n-k, and completes wavelength path routing.

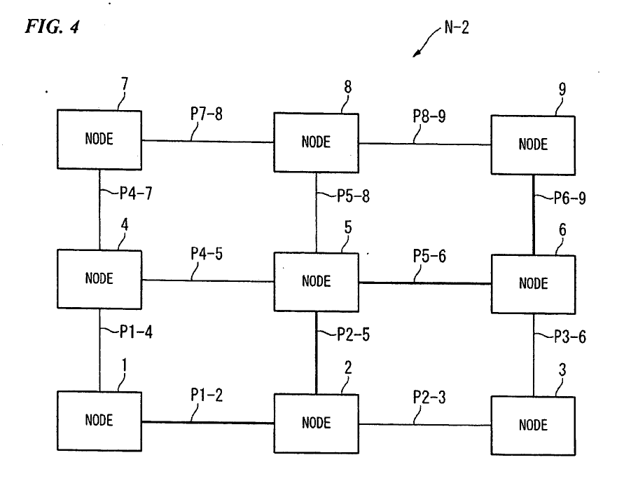

Next, Steps S3 to S6 that are executed by the wavelength route selection system A after alarm/quality supervision data collection in Step S2 of FIG. 3 will be described with reference to the drawing. That is, an example of a specific processing for route selection will be described. FIG. 4 is a diagram schematically showing the configuration of a wavelength division multiplexing network N-2 which is a network subject to route selection. In FIG. 4, the wavelength division multiplexing network N-2 includes nine nodes 1 to 9 that are arranged in a lattice shape of 3 vertical by 3 horizontal. The wavelength division multiplexing network N-2 includes 12 spans P1-2, P1-4, P2-3, P2-5, P3-6, P4-5, P4-7, P5-6, P5-8, P6-9, P7-8, and P8-9 connecting the nodes 1 to 9. The nodes 1 to 9 are connected to the wavelength route selection system A through control signal lines (not shown).

In the wavelength division multiplexing network N-2, similarly to the nodes 1-1 to n-k of FIG. 1, each of the nodes 1 to 9 has a wavelength cross-connect function and a function to output status information. In FIG. 4, for example, like the span P1-2 connecting the node 1 and the node 2, each span is represented by reference numeral based on a combination of reference numerals of two nodes connected to each other through the corresponding span.

With respect to route selection of the wavelength division multiplexing network N-2 of FIG. 4, a description will be provided in connection with an example where the wavelength route selection system A carries out the route selection processing on the basis of the following conditions.

The path setting unit A-2 stores the start node “Node 1” and the end node “Node 9” as wavelength path information on the basis of the operator's input.

The condition setting input unit A-1 stores the upper limit reliability threshold α “α=10” and the reliability weighted values shown in FIG. 2 on the basis of the operator's input.

That is, a wavelength route to be selected by the inhibition route setting unit A-5 is routes, which do not include spans whose span reliability R exceeds the upper limit reliability threshold α=10, among routes from the node 1 to the node 9.

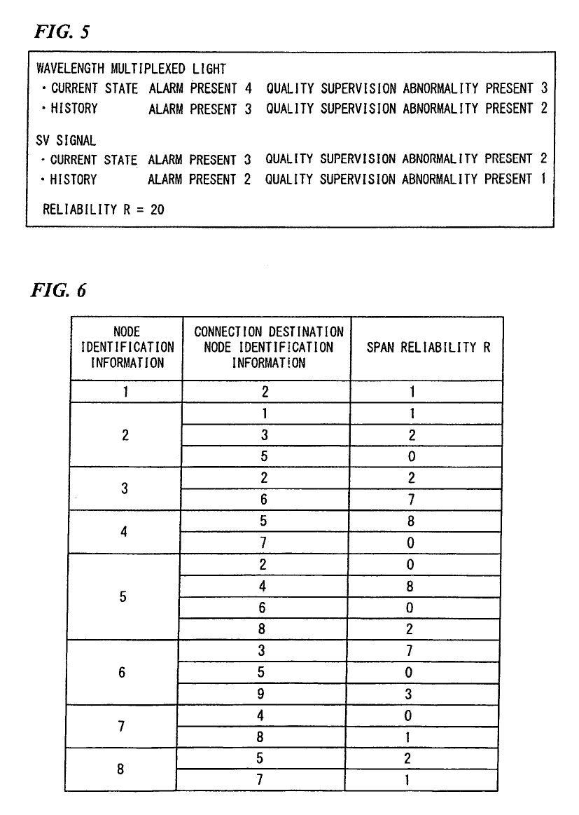

Next, as an example of calculation of the span reliability R in FIG. 4, calculation of the span reliability R of the span P1-4 will be described. FIG. 5 is a table in which status information of the span P1-4 collected by the data collection unit A-3 of the wavelength route selection system A is recorded in association with the reliability weighted values for the respective status information of FIG. 2. As shown in FIG. 5, in the current state and the history of the span P1-4, the alarm and quality supervision abnormality of wavelength multiplexed light are determined to be “Present”. In the span P1-4, the alarm and quality supervision abnormality of the SV signal are determined to be “Present”. The span reliability calculation unit A-4 adds the reliability weighted values of the respective status information of the span P1-4, and outputs the calculation result as the span reliability R of the span P1-4. The span reliability R is calculated by the following equation.

Span Reliability R=4+3+3+2+3+2+2+1=20

The span reliability calculation unit A-4 obtains the value 20 as the span reliability R of the span P1-4.

Similarly, the span reliability calculation unit A-4 calculates the span reliabilities R of all the spans of the wavelength division multiplexing network N-2.

The span reliabilities R of the span P1-2, the span P1-4, the span P2-3, tile span P2-5, the span P3-6, the span P4-5, the span P4-7, the span P5-6, the span P5-8, the span P6-9, the span P7-8, and the span P8-9 have the values 1, 20, 2, 0, 7, 8, 0, 0, 2, 3, 1, and 11, respectively.

After calculation of the span reliability R by the span reliability calculation unit A-4 in Step S2 of FIG. 3, the span reliability calculation unit A4 outputs the inhibition span exclusion/route extraction request including the span reliability R for each span to the inhibition route setting unit A-5.

In Step S3, the inhibition route setting unit A-5 reads out the upper limit reliability threshold α stored in the condition setting input unit A-1 on the basis of the input inhibition span exclusion/route extraction request. The inhibition route setting unit A-5 determines, as inhibition spans, spans whose span reliability R exceeds the read upper limit reliability threshold α=10. Here, the span P1-4 whose span reliability R becomes 20 and the span P8-9 whose span reliability R becomes 11 are determined as inhibition spans.

Next, extraction of routes from the node 1 to the node 9 by the inhibition route setting unit A-5 will be described. In this case, a procedure for extracting routes from the node 1 as the start node to the node 9 as the end node with the exception of an inhibition span will be described.

FIG. 6 is a table showing nodes as a connection destination of the nodes 1 to 8 through spans other than an inhibition span, and the span reliability R for a corresponding connection.

As shown in FIG. 6, the connection destination of the node 1 is the node 2. The connection destinations of the node 2 are the node 1, the node 3, and the node 5. The connection destinations of the node 3 are the node 2 and the node 6. The connection destinations of the node 4 are the node 5 and the node 7. The connection destinations of the node 5 are the node 2, the node 4, the node 6, and the node 8. The connection destinations of the node 6 are the node 3, the node 5, and the node 9. The connection destinations of the node 7 are the node 4 and the node 8. The connection destinations of the node 8 are the node 5 and the node 7.

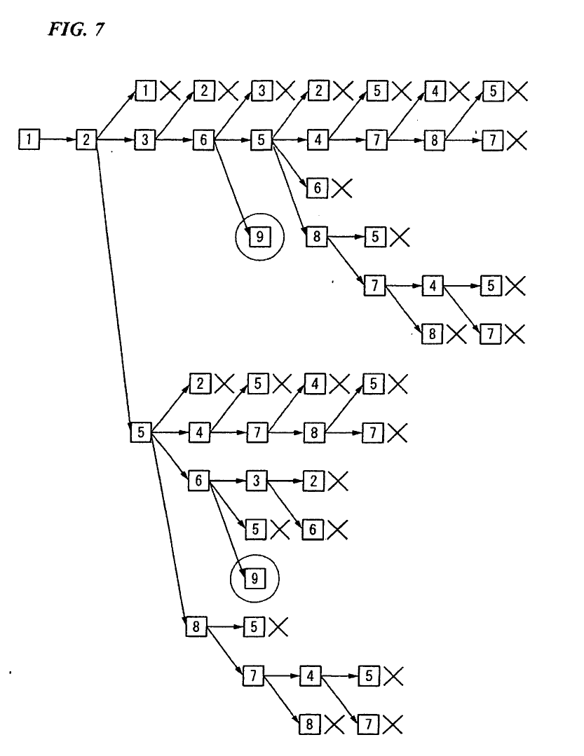

Route extraction by the inhibition route setting unit A-5 follows the connection destination nodes of each node with the start node as a start point in an ascending order of the identification numbers of the nodes, and when the end node comes, the extraction processing of the corresponding route ends. When a node in a route being currently extracted overlaps a connection destination node, the extraction processing of the corresponding route ends. Next, the inhibition route setting unit A-5 is moved to an extraction processing of a next different route. Therefore, the route selection processing follows the nodes in a tree form, as shown in FIG. 7.

FIG. 7 is a schematic view of a route to be followed by the inhibition route setting unit A-5 of FIG. 6 when the wavelength division multiplexing network N-2 of FIG. 4 carries out a route selection processing from the node 1 to the node 9. The node 1 is connected only to the node 2. The node 2 is connected to the node 1, the node 3, and the node 5.

The inhibition route setting unit A-5 follows a route of the node 1 to the node 2 as a first route. The inhibition route setting unit A-5 follows the node 1 having a minimum identification number from among the connection destination nodes of the node 2. Here, since the node 1 is duplicated, the inhibition route setting unit A-5 is moved to an extraction processing of a next route, without following the connection destination of the node 1 of the second time, thereby preventing a loop.

Therefore, a second route is a route of the node 1 to the node 2 to the node 3 to the node 2. Here, since the node 2 is duplicated, the inhibition route setting unit A-5 is moved to an extraction processing of a next route, without following the connection destination of the node 2 of the second time. In this way, a route which follows all the connection nodes of each node with the node 1 as a start point or a route in which a node is duplicated in the route is excluded. Accordingly, routes from the node 1 to the node 9 with no loop can be extracted. As shown in FIG. 7, in the wavelength division multiplexing network N-2 of FIG. 4, routes from the node 1 to the node 9 with the exception of an inhibition span are two routes including a first route “the node 1 to the node 2 to the node 3 to the node 6 to the node 9” and a second route “the node 1 to the node 2 to the node 5 to the node 6 to the node 9”.

If the route extraction processing is completed, the inhibition route setting unit A-5 outputs the request to calculate the route reliability R′ including the information regarding the extracted routes and the span reliabilities R of all the spans by the span reliability calculation unit A-4 to the route reliability calculation unit A-6. In Step S5 of FIG. 3, the route reliability calculation unit A-6 adds the span reliabilities R of the spans in each route on the basis of the information of the first route and the second route and the span reliabilities R from the inhibition route setting unit A-5 so as to calculate the route reliability R′.

In this case, the first route includes the span P1-2, the span P2-3, the span P3-6, and the span P6-9. That is, with respect to the span reliabilities R of the spans in the first route, the span reliability R=1, the span reliability R=2, the span reliability R=7, and the span reliability R=3. Therefore, the route reliability R′ of the first route which is calculated by the route reliability calculation unit A-6 is as follows.

Route Reliability R′=1+2+7+3=13

The second route includes the span P1-2, the span P2-5, the span P5-6, and the span P6-9. In this case, the span reliability R=1, the span reliability R=0, the span reliability R=0, and the span reliability R=3. Therefore, the route reliability R′ of the second route which is calculated by the route reliability calculation unit A-6 is as follows.

Route Reliability R′=1+0+0+3=4

If the calculation processing of the route reliability R′ is completed, the route reliability calculation unit A-6 outputs the route selection/setting request including the information regarding the routes extracted by the inhibition route setting unit A-5 in association with the calculated route reliabilities R′ of the routes to the route selection/setting unit A-7.

With respect to Step S6 of the FIG. 2, the route selection/setting unit A-7 compares the input route reliabilities R′ of the routes with each other, and selects a route having a minimum route reliability R′ as a wavelength path from the node 1 to the node 9. In this case, the route reliability R′=13 of the first route is larger than the route reliability R′=4 of the second route. For this reason, the route selection/setting unit A-7 selects the second route as a wavelength path from the node 1 to the node 9.

According to the foregoing embodiment, the wavelength route selection system A uses reliability information of wavelength multiplexed light and an SV signal at a node in an existing system as determination factors for route selection of the wavelength path.

Since route selection is carried out on the basis of the reliability information, the wavelength route selection system A can select a wavelength path with high reliability in the network subject to route selection.

According to this embodiment, since route selection is carried out on the basis of output of reliability information at a node in the existing system, route selection can be carried out, without providing a new device, such as a device for measuring the status of each span. Therefore, the wavelength route selection system A can achieve ease of expansion from the existing system, and can select a wavelength path with high reliability in the network subject to route selection at low cost.

In the wavelength route selection system A, the inhibition route setting unit A-5 determines an inhibition span using the upper limit reliability threshold α that is the upper threshold of the span reliability R. Therefore, candidate routes can be limited, and the amount of calculation of the route selection processing can be suppressed.

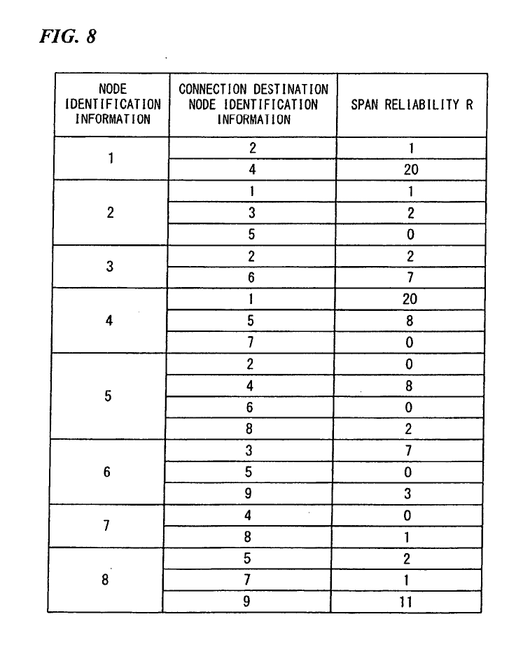

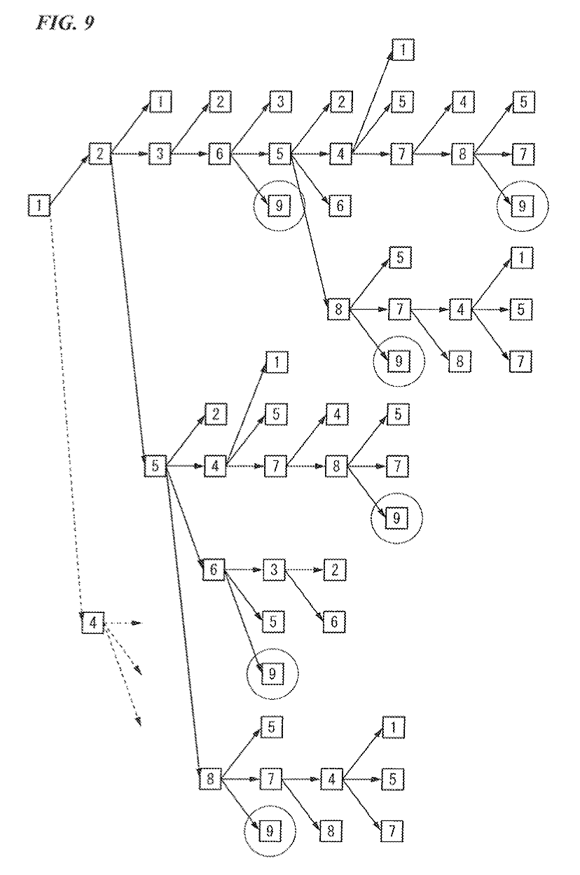

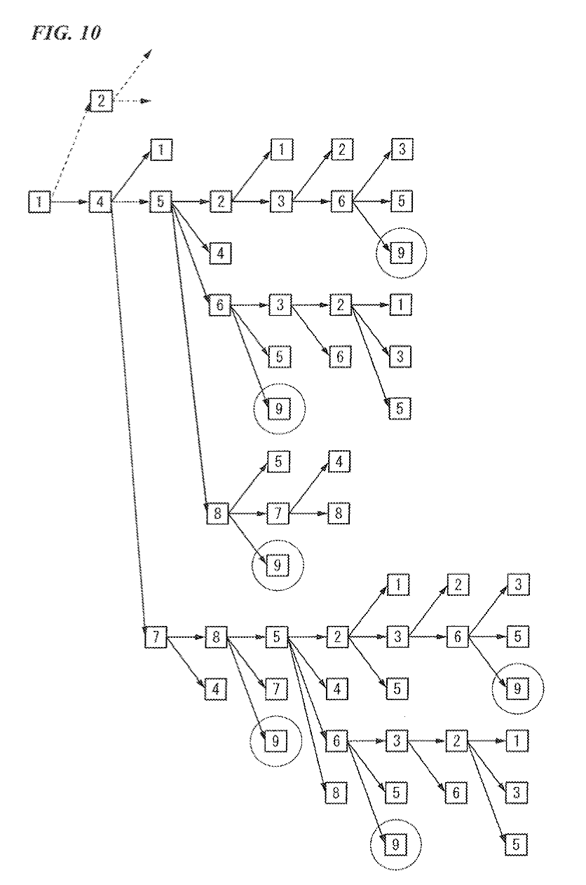

Specifically, for example, in FIG. 4, when an inhibition span is not excluded, as shown in FIG. 8, at the node 1, the node 4, and the node 8, the number of connection destination nodes increases. FIGS. 9 and 10 are tree diagrams schematically showing a route that the inhibition route setting unit A-5 follows when an extraction processing from the node 1 to the node 9 is applied to the nodes 1 to 9 in a connection relationship shown in FIG. 8. FIG. 9 is a schematic view showing route extraction of the node 1 as a start node to the node 2. FIG. 10 is a schematic view showing route extraction of the node 1 as a start node to the node 4.

As compared with FIG. 7 in which an inhibition span is excluded, in FIGS. 9 and 10 in which an inhibition span is not excluded, the number of routes at the time of extraction increases. In this embodiment, there are two routes from the node 1 to the node 9. In contrast, when all the spans are used, there are twelve routes. For this reason, in order to select a wavelength path with high reliability from among the twelve routes, the amount of calculation increases.

As described above, in this embodiment, in the wavelength route selection system A, an inhibition span is excluded on the basis of the upper limit reliability threshold α. Therefore, the amount of calculation for route extraction or the amount of calculation for the selection processing of a wavelength path with high reliability from among the extracted routes can be suppressed. Furthermore, the processing time can be shortened, and thus delay can be suppressed.

In this embodiment, a wavelength path is selected using both the alarm and quality supervision information as reliability information of the wavelength multiplexed signal and the alarm and quality supervision information as reliability information of the SV signal. In a relay processing at a relay node, an input optical signal is relayed as it is, with no conversion of an optical signal into an electrical signal. For this reason, the reliability information of the wavelength multiplexed signal at each span includes only the alarm of LOS (Loss of Signal) representing signal termination, a change in the level of an optical signal, such as a level degradation, or level stability of an optical signal. This makes it impossible to measure an error rate of a signal which may be measured from the start node to the end node. Meanwhile, the SV signal is inserted into the optical signal for each span and branched off. For this reason, in addition to the alarm of LOS, the error rate can be detected. Therefore, the span reliability R is calculated based on a combination of the reliability information of the wavelength multiplexed signal and the reliability information of the SV signal. As a result, the accuracy of quality evaluation for reliability evaluation of each span can be improved.

While in the foregoing embodiment the weighted values are given depending on presence/absence of abnormality or an alarm in the past history from among the status information, the invention is not limited thereto. For example, the number of alarms or the like in the past may be set as a weighted value. In this case, different values may be set as a weighted value such that a large value is set depending on the number of alarms or abnormalities in the past history. Furthermore, in terms of an occurrence frequency of an alarm or abnormality for a predetermined time, when the occurrence frequency increases, a larger value may be set as a weighted value.

The span status information corresponds to the reliability information of the wavelength multiplexed signal and the reliability information of the SV signal. The upper limit of the span reliability corresponds to the upper limit reliability threshold α. The supervision control signal corresponds to the SV signal.

The above-described wavelength route selection system A internally has a computer system. The operations of the condition setting input unit A-1, the path setting unit A-2, the data collection unit A-3, the span reliability calculation unit A-4, the inhibition route setting unit A-5, the route reliability calculation unit A-6, and the route selection/setting unit A-7 of the wavelength route selection system A are stored in a computer-readable recording medium in the form of a program. If the computer system reads out and runs the program, the above-described processing is carried out. The term “computer system” used herein is a concept including a CPU, various memories, the OS, and hardware including peripheral devices and the like.

When the WWW system is used, the “computer system” may also include a homepage provision environment (or display environment).

A program for implementing the respective steps shown in FIG. 3 may be recorded in a computer-readable recording medium. A program for implementing the function of the wavelength route selection system A shown in FIG. 1 may be recorded in a computer-readable recording medium. In this case, if the computer system reads out the program recorded in the recording medium and runs the program, a route with high reliability may be selected and set as a wavelength path with high importance in the wavelength division multiplexing network.

The term “computer-readable recording medium” used herein includes a writable non-volatile memory, such as a flexible disk, a magneto-optical disk, a ROM, a flash memory, a movable medium, such as a CD-ROM or the like, and a storage device, such as a hard disk or the like, embedded in the computer system.

The term “computer-readable recording medium” is a concept including a device which stores a program for a predetermined time, such as a non-volatile memory (for example, a DRAM (Dynamic Random Access Memory)) in the computer system serving as a server or a client when the program is transmitted through a network, such as Internet or the like, or a communication link, such as a telephone link or the like.

The program may be transmitted from a computer system, which stores the program in a storage device or the like, to another computer system through a transmission medium or a transmission wave in the transmission medium. The “transmission medium” for transmission of the program refers to a medium having a function to transmit information, for example, a network (communication network), such as Internet or the like, or a communication link (communication line), such as a telephone link or the like.

The program may implement part of the above-described function. Further, the program may be a differential file (differential program) that may implement the above-described function in combination with a program, which is recorded in the computer system in advance.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A wavelength route selection system, the system comprising:
a data collection unit receiving span status information representing status of each of spans for connection to the different node devices to the spans from a plurality of node devices;
a span reliability calculation unit calculating span reliabilities of each of the spans on the basis of the span status information received by the data collection unit;
an inhibition route setting unit determining, for each of the spans, whether or not the span reliability calculated by the span reliability calculation unit exceeds an upper limit value of the span reliability representing the reliability of each of the spans, and the inhibition route setting unit extracting, as second wavelength routes, routes based on the spans, the span reliability of which is determined to exceed the upper limit value, from among wavelength routes from the node device as the start point to the node device as the end point;
a route reliability calculation unit adding, for each of the second wavelength routes extracted by the inhibition route setting unit, the span reliabilities of all the spans in the corresponding second wavelength route calculated by the span reliability calculation unit so as to calculate a wavelength route reliability representing the reliability of the second wavelength route;
a route selection unit selecting the second wavelength route having a minimum wavelength route reliability calculated by the route reliability calculation unit from among the second wavelength routes as the first wavelength route from one of the node devices as a start point to another of the node devices as an end point; and
a setting unit setting the first wavelength route selected by the route selection unit in the plurality of node devices.

2. The wavelength route selection system according to claim 1,
wherein the span status information includes an alarm of a wavelength multiplexed signal, quality supervision information of the wavelength multiplexed signal, an alarm of a supervision control signal, and quality supervision information of the supervision control signal.

3. The wavelength route selection system according to claim 1,
wherein the span reliability calculation unit calculates the span reliability on the basis of current span status information and past span status information from among the span status information.

4. A wavelength route selection method, the method comprising:
receiving span status information representing status of each of spans for connection to the different node devices to the spans from node devices;
calculating span reliabilities of each of the spans on the basis of the received span status information and weighted values for the respective span status information;
determining, for each of the spans, whether or not the calculated span reliability exceeds an upper limit value of the span reliability representing the reliability of each of the spans, and extracting, as second wavelength routes, routes based on spans, the span reliability of which is determined to exceed the upper limit value, from among wavelength routes from the node device as the start point to the node device as the end point;
adding, for each of the extracted second wavelength routes, the span reliabilities of all the spans in the corresponding second wavelength route so as to calculate a wavelength route reliability representing the reliability of the second wavelength route;
selecting the second wavelength route having a minimum wavelength route reliability from among the second wavelength routes as the first wavelength route from one of the node devices as a start point to another of the node devices as an end point; and
setting the selected first wavelength route in the plurality of node devices.
